(19) United States
(12) Patent Application Publication
(10) Pub. No.: US 2007/0199416 A1
(43) Pub. Date: Aug. 30, 2007

(54) Band saw blade

(76) Inventors: James Timothy Cook, Newton, AL (US); Stephen Othniel Cook, Newton, AL (US)

Correspondence Address: Curtis W. Dodd, 2803 Bentley Street, Huntsville, AL, 35801-2220, US

(21) Appl. No.: 11/399,197

(22) Filed: Apr. 6, 2006

Related U.S. Application Data
(60) Provisional application No. 60/776,634, filed on Feb. 25, 2006.

(51) Int. Cl. B26D 1/46

(52) U.S. Cl. 83/13; 83/661

(57) ABSTRACT

The invention relates to the structure of a band saw blade. The band saw blade has teeth with an improved geometrical shape that increases the efficiency of the blade. The tooth shape of a band saw blade is defined in part by the back angle and the hook angle, wherein the back angle of the disclosed embodiment exceeds the value of back angle of conventional band saw blades.

### CROSS-REFERENCE TO RELATED APPLICATIONS

This application is related to Cook, U.S. Provisional Patent Application No. 60/776,634, entitled “Band Saw Blade” filed on Feb. 25, 2006 and is incorporated by reference herein, with priority claimed for all commonly disclosed subject matter.

### FIELD OF THE INVENTION

The present invention generally relates to the field of band saw blades for cutting wood and other materials.

### RELATED ART

The teeth of a band saw blade work as tiny planing tools that generate chips at a high speed by planing and/or tearing, the chips being collected and removed in the tooth gullets. The development of increasingly efficient band saws has aimed at further developing this planing and/or tearing function of band saw blades. It is a typical feature of band saw blades that the teeth are set, swaged or otherwise configured so as to provide a kerf (a space generated by the cutting) that is somewhat greater than the blade thickness, for example, twice the blade thickness. The kerf provides a widened path for passing the body of the blade through the material being cut. In addition, the kerf serves as a channel for removal of material waste, such as, for example, sawdust in an industrial wood cutting operation. In such wood cutting operations, the blade may have a thickness of twenty thousandths of an inch and the kerf thickness may be fifty thousandths of an inch.

Current blade developments and improvements are brought about by taking advantage of new materials, advanced manufacturing techniques, and modifications in blade geometry. There are certain accepted requirements or standards for parameters of a band saw blade as well be seen. Such standards generally guarantee that blades have strong teeth and operate for a designated amount of time without requiring maintenance.

Generally, a band saw blade is replaced because of tooth wear, stress or some other performance limiting problem. A worn blade, such as a blade with worn teeth, causes an undesirable loss in efficiency that may cause the blade to break due to increased stress. In addition, a worn blade may cause damage to the band saw body that is pulling the blade. A worn blade also increases power requirements thereby increasing the energy expense of the sawing operation. In general, a first saw blade is said to be efficient than a second saw blade when the first blade requires less energy for performing a desired cutting action.

Hence it is desirable to minimize tooth wear in order to have an efficient sawing operation.

Further, a wood sawing operation generally becomes more productive and profitable when the amount of time between blade changes increases. For example, in a continuous sawing operation, changing a blade every 8 hours usually causes twice the band saw downtime as changing a blade every 16 hours. In general, a sawmill using a band saw regards downtime as undesirable since there is a cost associated with non-productive use of the saw.

Consequently, it is desirable to have an improved blade that minimizes downtime and energy use.

Blade material and blade processing, such as improved heat treatment, have resulted in desirable improvements in blade efficiency. By selecting an improved blade stock material and using advanced treatment techniques, blades have been significantly improved.

Blade shaping, i.e. modifying the geometric shapes associated with the blade, is also used for improving blade efficiency. Blade shapes are described in manufacture's literature and in patents such as those referenced below. Such shape modifications, for example, include varying tooth spacing, sharpening multiple blade surfaces, alternating tooth set patterns and changing other shapes associated with the blade.

Related publications that provide additional background material are included to provide an understanding of blade structure, prior art blade attributes and other blade characteristics. The disclosures of each patent are hereby incorporated herein by reference in their entirety:

U.S. Pat. No. 6,598,509, Jul. 29, 2003, Cutting Tool Tooth Form Including Set Teeth with Surface Features and Method of Making Same; U.S. Pat. No. 6,681,674, Jan. 27, 2004, Band Saw Blade; U.S. Pat. No. 6,276,248, Aug. 21, 2001, Band Saw Blade Having Reduced Noise and Uniform Tooth Loading Characteristics; U.S. Pat. No. 4,011,783, Mar. 15, 1977, Circular Saw; U.S. Pat No. 4,423,553 Jan. 3, 1984, Blade for a Saw and a Method for Manufacturing the Same; U.S. Pat. No. 4,557,172 Dec. 10, 1985, Saw Blade; U.S. Pat. No. 4,727,788 Mar. 1, 1988, Saw Blade; U.S. Pat. No. 4,813,324 May 9, 1989, Saw Blade; U.S. Pat. No. 4,827,822 May 9, 1989, Saw Blade; U.S. Pat. No. 5,331,876 Jul. 26, 1994, Saw Blade for Cutting Metal; U.S. Pat. No. 5,425,296 Jun. 20, 1995, Saw Blade; U.S. Pat. No. 5,477,763 Dec. 26, 1995, Saw Blade; U.S. Pat. No. 5,603,252, Feb. 18, 1997, Saw Blade; WO/98/07545 Feb. 26, 1998, Tooth Structure of Band Saw Blade.

### SUMMARY OF THE DISCLOSURE

Generally, the present invention provides a band saw blade with a novel geometrical structure for improving the efficiency and performance of a blade.

In one embodiment of the disclosure a band saw blade is comprised of a blade having a base and one or more teeth. The teeth extend from the top surface of the base and have an edge formed by the intersection of a backside surface and a face surface. The back angle of at least one of the teeth has a value greater than 32 degrees. In another embodiment of the disclosure, teeth of the blade have a back angle between 35 and 50 degrees.

Various features and advantages of the present disclosure will become apparent to one skilled in the art upon examination of the following detailed description, when read in conjunction with the accompanying drawings. It is intended that all such features and advantages be included herein within the scope of the present disclosure.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the several views.

FIG. 1 illustrates a side view a band saw blade.

FIG. 2A illustrates a top view of the band saw blade of FIG. 1. with swaged teeth.

FIG. 2B illustrates a top view of the band saw blade of FIG. 1. with set teeth.

FIG. 2C illustrates a cross section of the band saw blade of FIG. 1. with swaged teeth.

FIG. 2D illustrates a cross section of the band saw blade of FIG. 1. with set teeth.

FIG. 3 illustrates an embodiment of the band saw blade of the present disclosure.

FIG. 4 illustrates another embodiment of the band saw blade of the present disclosure.

### DETAILED DESCRIPTION

The present invention generally pertains to band saw blades and the geometrical structure of such blades. A brief description of blade geometry is. provided for a conventional blade and is further used to define terms suitable for describing embodiments the band saw blade of the present disclosure.

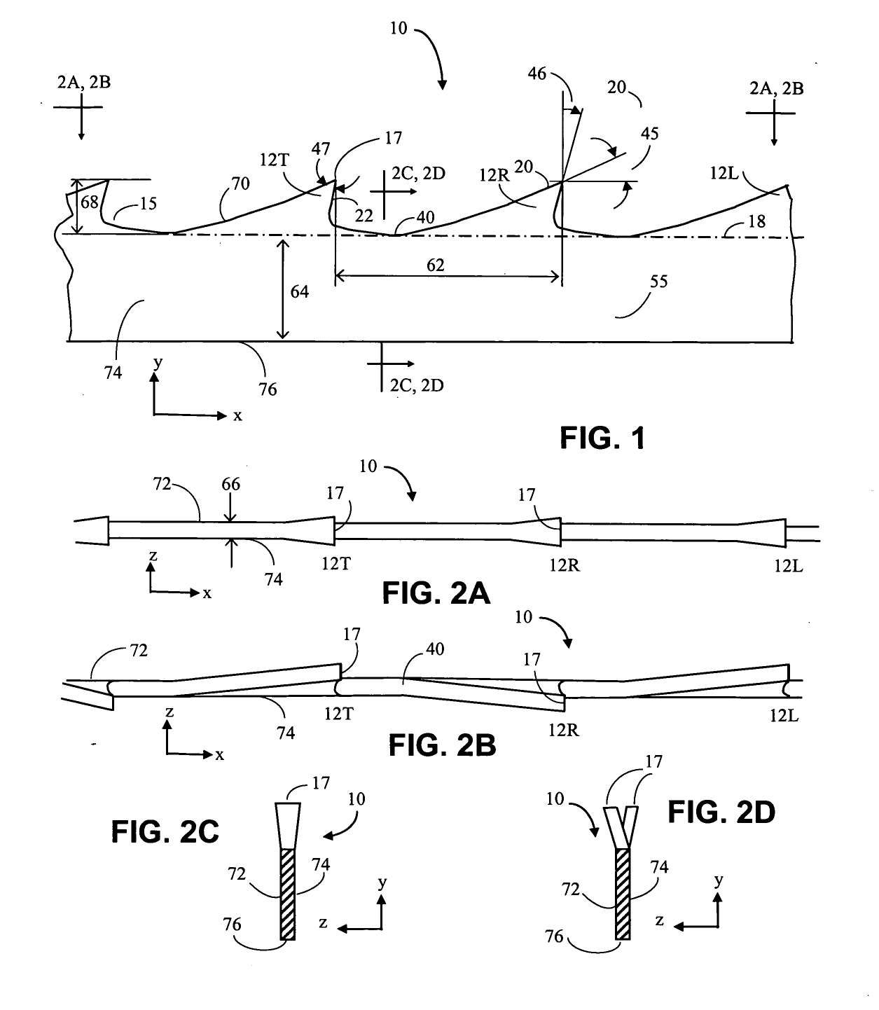

Referring to FIG. 1 there is shown a conventional blade 10 having teeth 12 that remove material from a work piece (not shown), such as, for example a log or other piece of wood. The blade 10 moves in the x direction and the work piece moves in the negative y direction. A reference tooth 12R is adjacent to a leading tooth 12L, located in the x direction from the reference tooth 12R. The leading tooth 12L removes some material from the work piece before the reference tooth 12R makes contact with the work piece. A trailing tooth 12T, also adjacent to the reference tooth 12R and located in the negative x direction from the reference tooth 12R, makes contact with the work piece some time after the reference tooth 12R has made contact. The band saw blade forms an endless loop, as is understood by those skilled in the art, so that each tooth repeatedly removes material from the work piece.

The teeth 12 of the blade in FIG. 1 have an edge surface 17 (the point of the tooth) that cuts the work piece by penetrating into and removing material. Extending in the negative x direction and slightly downward (the negative y direction) from the edge surface 17 is the backside or back surface 20 of the tooth 12. The front side 22 of the blade is often referred to as the face of the tooth. The lower part of the front side 22 is generally referred to as the gullet 15 of the tooth 12. The area of the blade 10 above, in the y direction, a reference line 18 is referred to as the tooth area of the blade. The area of the blade 10 below, the negative y direction, the reference line 18 is a base 55 of the blade 10. The distance between the teeth, measured in the x direction is referred to as the tooth spacing distance 62 as seen in FIG. 1. The blade back surface 20 intersects the blade face 22 of the tooth 12 to form the edge 17. Each tooth has a back angle 45 that is defined as the angle between an extension of the back surface 20 at the edge 17 and a line parallel to the reference line and extending from the edge 17 as shown in FIG. 1. The back angle 45 for the conventional band saw blade 10 is 31 degrees (a de facto standard). Accepted analysis and insight indicate that such an angle provides a blade 10 with strong teeth 17, thereby reducing the chance of one or more of the teeth 17 of a conventional band saw blade 17 being broken or sheared off by fatigue or otherwise as it continuously impacts the material that is being cut. The inventors have observed at least one manufacturer that sells a band saw blade that has a back angle 45 of 26 degrees. The manufacturer has indicated that such a blade has stronger teeth that those provided by the standard back angle of 31 degrees.

In addition to having a back angle 45, each tooth 12 has a hook angle 46 (sometimes referred to as the face angle) that is measured between a vertical line extending upward, the y direction, from the tooth edge 17 and an upward extension of the face surface 22. The hook angle 46 as shown in FIG. 1 is a positive angle (measure from the vertical line in a clockwise direction) of around 10 degrees. It is generally accepted that the hook angle 46 for conventional blades is about 10 degrees, although hook angles with values of as little as 5 degrees have been used for some blades. Each tooth 12 of the conventional blade also has a tooth angle 47, defined as the angle between the back surface 20 and the face surface 22 of the tooth 12. The tooth angle 47 has a value of 49 degrees when the back angle is 31 degrees and the hook angle is 10 degrees as may be determined from the geometry of the tooth 17. Each tooth 12 of a saw has a gullet 15 below the tooth edge 17 that generally has a concave shape as shown in FIG. 1.

The band saw blade 10 has a left side with a left side surface 74 and a right side with a right side surface 72. The sides, left side or right side, are defined and identified when an observer looks into the face 22 of the tooth 12 as being to the observer's left (the negative z direction) and to the observer's right (the z direction).

When looking downward, the negative y direction, the top of tooth edges 17 can be seen in FIG. 2A. The conventional blade 10 has a thickness 66 as measured between the left side surface 74 and a right side surface 72. Although the sides of each tooth 17 are generally parallel to the sides of the base 55 the teeth as shown in FIG. 2A are swaged and are thicker than the blade base in order to provide a kerf as earlier described. FIG. 2B illustrates a blade having teeth that are set, i.e. bent outward, for removing material to form the kerf. A cross section is shown for a blade having swaged teeth in FIG. 2C. A blade having set teeth is shown in the cross section view of FIG. 2D. Setting teeth, swaging teeth or otherwise widening the cutting path on a band saw blade is needed to form the kerf that serves as a channel from disposing of removed material, such as wood chips or sawdust, as is understood by those skilled in the art. The gullet 15 of the conventional blade 10 serves as a scoop or collection point for pulling wood chips away from work piece and through the kerf formed by the planing action of the edges 17 of the teeth 12.

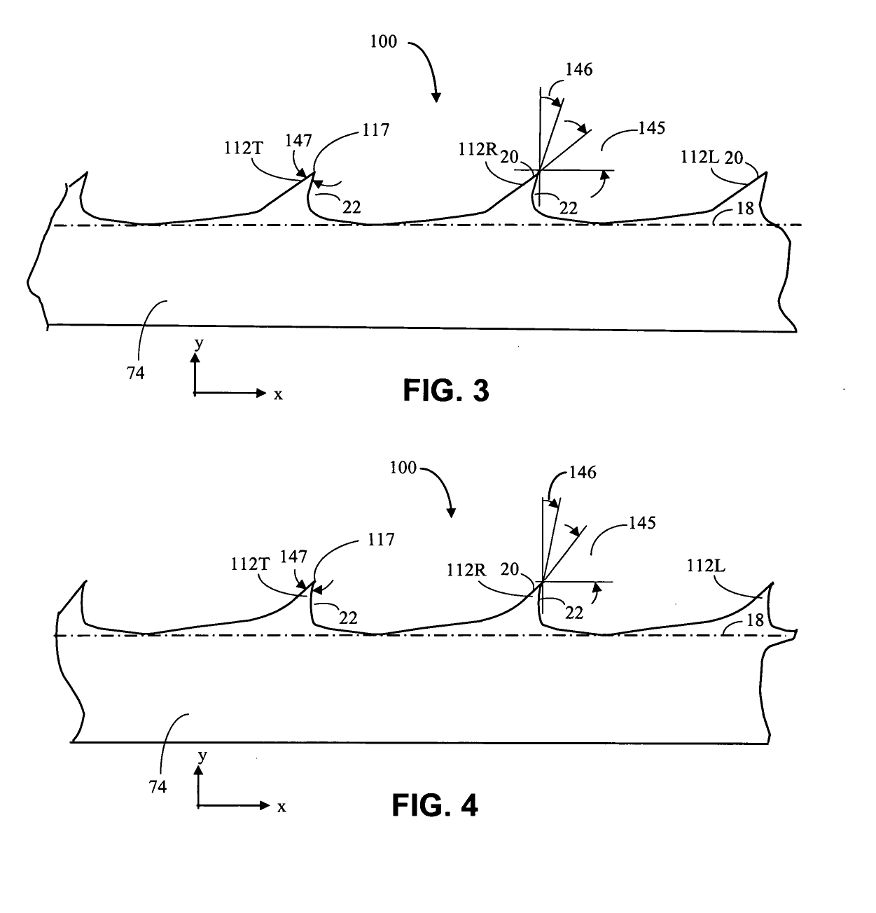

An embodiment of a band saw blade 100 of the present disclosure is illustrated in FIG. 3. Contrary to conventional teachings, a back angle 145 as shown is FIG. 3 is 46 degrees. A hook angle 146 for the embodiment of the improved band saw blade 100 is 10 degrees. The back angle 146 of the disclosed embodiment 100 is 15 degrees steeper than the back angle 46 of the conventional band saw blade 10. Because the back angle is steeper (numerically greater) the tooth angle 147 of the disclosed embodiment of improved band saw blade 100 is deceased thereby smaller than the tooth angle 47 for the conventional blade 10. Because the tooth angle 146 of the disclosed embodiment of improved blade 100 is smaller, the tooth of the blade penetrates material, such as wood, to a greater depth. The greater penetration of tooth 112 results in more material removal. Hence, the disclosed embodiment of the improved band saw blade 100 having teeth with a steeper back angle 145 removes more material than the conventional blade having a back angle 45 of the standard 31 degrees. The inventors have determined by analysis and experimentation that when the tooth 112 of the disclosed band saw blade 100 makes such greater penetration the blade operates more efficiently and stays sharp longer. Since the teeth 112 of the improved blade 100 make deeper penetration than the teeth 12 of the convention blade 10, the wood chips produced by the improved blade 100 produce larger wood chips, i.e. the sawdust is coarser. In view of the fact that it is easier for the gullet 15 to remove coarse sawdust, the feature of having larger wood chips is desirable.

In one experiment using an embodiment of the band blade 100 where the back angle 145 is 36 degrees, the time between blade changes increased from 8 hours to 17 hours. Further, during the sawing operation using the improved blade 100, the amount of power required decreased when compared with the conventional blade 10.

In other experiments the inventors have determined that having a back angle of 32 degrees provides improved performance. Blade performance is improved for embodiments of the disclosed blade 100 when back angles are 32 degrees or greater. Geometry and structural analysis indicate that there is a upper limit on the back angle of perhaps 60 degrees or so. Although experiments have been limited to back angles between of 32 degrees and 46 degrees the inventors believe their disclosure includes any back angle 146 greater than or equal to 32 degrees and any hook angle between −5 and 15 degrees.

FIG. 4 illustrates an embodiment of the disclosure wherein the back angle 145 is 55 degrees and the hook angle 146 is 10 degrees. The teeth 112 of the embodiment of FIG. 4 have a tooth angle 147 of 25 degrees. The teeth as illustrated, because of the narrow tooth depth, have the capacity for greater penetration and more efficiency that the conventional blade 10. Although analysis indicates that the tip strength is reduced, such a blade may be an improvement over the conventional blade 10 when considering efficiency and downtime. The inventors intend to determine the limits on the values of the back angle 145 and hook angle 146 through further analysis and experimentation.

Experiments performed at several sawmills have provided unexpected results. Although the concerns of reduced tip strength, though probably correct, operational experiments have not shown this as a problem for the disclosed saw blade 100. The experiments, occurring at several sawmills under a variety of conditions, demonstrate that the efficiency of blades with a back angle of 36 degrees is increased between 50% and 400%. The blades 100 of the disclosed embodiment stayed sharp longer and therefore reduced the energy requirements the band saw 100 under constant feed rate of wood. Further, because the improved blades 100 stayed sharp longer it was not necessary to change as of ten, thereby was a reducing band saw downtime. The reduction in saw downtime means the band saw generally produces more board feet over given period of time.

The inventors have also determined that the value of the back angle is related to the hardness of the wood being cut. For example, for a soft wood such as southern pine, the back angle 145 can be greater than the back angle 146 for a hard wood, such as for example a dense maple or oak. In the disclosed embodiments the preferred hook angle is between 3 and 12 degrees although other values fall within the scope of the present disclosure.

Observations from the experiments on blades with back angles of 36 degrees or more, when used for cutting wood, are as follows:

Teeth with a 36 degree back angle penetrate wood about 50% easier than the teeth of conventional blades;

When the back angle is greater than 36 degrees tooth penetration further improves;

The blade having teeth with a 36 degree back angle remains sharper up to four times longer than teeth of a conventional blade.

The amount of energy required to saw a work piece is decreased thereby reducing energy cost; and

The tooth penetrates more easily as the back angle is increased, but the chance of a tooth tip breaking may also increased, although there has been no problems with a tip breaking;

These and other benefits of the disclosed embodiments indicate that it is desirable to change the geometry of blades in accordance with the above descriptions. The benefits of the disclosure may be combined with other blade improvements to provide cost reduction for band saw operation at sawmills and other facilities.

The disclosed embodiments may be incorporated in blades during manufacturing or conventional blades may have material removed to provide a back angle as described in the disclosed embodiments. When a conventional blade is reworked to provide a blade in accordance to the disclosure, the backside of the blade may not have the smooth shape as shown in FIG. 3 and FIG. 4. Experimental results that have demonstrated the desirable features of the disclosure include blades that have been reworked. For example, the inventor has indicated, via a test, that in February of 2006 he sent a reworked and improved saw blade to a client, who normally runs a blade for 7 hours before disposing of the blade. The client used the new blade for 17 hours and the blade was still cutting as new.

It should be further emphasized that the above-described embodiments of the present invention, particularly, any “preferred” embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the claims of a utility application.

1. A band saw blade comprising:
a base for supporting teeth, the base having a top surface defined by a reference axis; and
teeth extending from the top surface wherein each tooth has a face surface and a back surface intersecting to form edges for each tooth and wherein the back angle of at least one tooth is thirty two degrees or more.

2. The band saw blade of claim 1 wherein the hook angle is between zero and fifteen degrees.

3. The band saw blade of claim 1 wherein the back angle is between 35 degrees and 60 degrees.

4. The band saw blade of claim 1 wherein the tooth angle, defined by the backside surface and the front side service has a value less than 60 degrees.

5. The band saw blade claim 2 wherein the back angle is greater that 35 degrees.

6. The band saw blade of claim 1 where one or more of the teeth of a conventional blade is modified to have a back angle of at least 32 degrees.

7. A tooth supported by a base of a band saw blade, the tooth structure comprising:
a tooth base abutted to the band saw blade base;
a backside surface extending from the tooth base;
a face surface extending from the tooth base, wherein the face surface intersects the backside surface forming a tooth edge;
and a back angle that is at least 32 degrees where the back angle is measured between a line parallel to the tooth base and a line extending tangentially from the backside of the tooth edge wherein the lines intersect at the tooth edge.

8. The tooth of claim 7 wherein the back angle is between 35 degrees and 70 degrees.

9. The tooth of claim 7 wherein the tooth has a tooth angle of less than 49 degrees, where the tooth angle is defined as the obtuse angle between the backside surface and the front side surface.

10. The tooth of claim 7 wherein the tooth has a hook angle is between minus 5 and plus 10 degrees.

11. The tooth of claim 7 wherein the teeth have a set for producing a kerf.

12. A band saw blade comprising:
a base for supporting teeth where the base has a top surface, side surfaces and a bottom surface;
one or more first teeth that have a back angle of 31 degrees or less; and
one or more second teeth that have a back angle greater than 31 degrees.

13. The blade of claim 12 wherein the first teeth and the second teeth have a hook angle greater than zero degrees.

14. The blade of claim 12 where the first teeth have a tooth angle greater than or equal than the tooth angle of the second teeth.

15. The blade of claim 12 where the second teeth have a tooth angle less than 49 degrees.

16. The blade of claim 12 wherein some of the blade teeth are set.

17. The blade of claim 12 wherein the teeth are spaced at equal distances.

18. A method for cutting material comprising the steps of:
providing a band saw blade with teeth having a back angle greater than 32 degrees;
rotating the band saw blade; and
bringing the band saw blade into contact with the material.

19. The method of claim 18 wherein the back angle is greater than 40 degrees.

20. The method of claim 18 wherein the teeth have a tooth angle less than of 49 degrees.
